(19) United States
(12) Patent Application Publication
(10) Pub. No.: US 2006/0038742 A1
(43) Pub. Date: Feb. 23, 2006

(54) Method and apparatus of controlling a liquid crystal display viewing area

(75) Inventors: Robert J. Lowles, Waterloo (CA); James A. Robinson, Elmira (CA); Brian A. Young, Waterloo (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: Research In Motion Limited, Waterloo, Ontario (CA)

(21) Appl. No.: 10/521,798

(22) PCT Filed: Jul. 23, 2003
(86) PCT No.: PCT/CA03/01105

§ 371 Date: Jan. 21, 2005

(51) Int. Cl. G09G 5/00

(52) U.S. Cl. 345/1.3

(57) ABSTRACT

An LCD with a viewing area, which comprises a first area and a second area, whereby the first area can be set to indicate event changes. Event changes, such as message received, urgent message received, new application in use, backlight turned on, and backlight turned off, can be indicated with different colours or different patterns within the first area of the viewing area. The second area is used for displaying images. There is also provided for a method for indicating event changes in a first area of a viewing area, the viewing area being part of a liquid crystal display (LCD), comprising the steps of providing control information, determining a first drive signal for said event change based on said control information, and supplying a first group of pixels in said first area with said first drive signal, said first group of pixels comprising at least one pixel, thereby controlling a colour of said first group of pixels with said first drive signal

### TECHNICAL FIELD

The invention relates generally to the control of flat panel displays (FPDs) such as liquid crystal displays (LCDs). More specifically the invention relates to dynamic control of the colour or colours of a viewing area of a liquid crystal display.

### BACKGROUND ART

The viewing area of an LCD is an area of the LCD that is visible through a bezel or cut-out in a case or cover of an electronic device. The viewing area of the LCD comprises two different areas, an inactive first area and an active second area on which images are displayed. The active area is a conductive area composed of many picture elements (pixels), whereas the inactive area is adjacent to and surrounding the active area.

Currently, LCD's are manufactured so that the inactive area displays a solid colour. Usually, a black or white mask is inserted within the inactive area of the LCD, thereby making the inactive area either black or white. In some known LCDs, the inactive area comprises four large pixels, each pixel being adjacent to the active area and the four pixels together forming a rectangular form, so as to surround the active area. These pixels have typically been hard-wired to be on or off to thereby make the inactive area either black or white.

### DISCLOSURE OF INVENTION

In a first aspect, a method for indicating an event change in a first area of a viewing area of a liquid crystal display (LCD), the LCD viewing area having a second area, surrounded by said first area, for displaying images, comprises the steps of providing control information, determining a first drive signal for said event change based on said control information, and supplying a first group of pixels in said first area with said first drive signal, said first group of pixels comprising at least one pixel, thereby controlling a colour of said first group of pixels with said first drive signal.

According to another aspect of the invention, In one embodiment, there is provided a liquid crystal display (LCD) comprising: a first area, for indicating at least one event change and a second area, adjacent to the first area, for displaying images.

Other aspects and features of the present invention will become apparent to those ordinarily skilled in the art upon review of the following description of specific embodiments of the invention in conjunction with the accompanying figures.

### BRIEF DESCRIPTION OF DRAWINGS

Embodiments of the present invention will now be described, by way of example only, with reference to the attached figures, wherein:

FIG. 1a is a top view of an electronic device with an LCD.

FIG. 1b is a top view of a known LCD.

FIG. 2a is a top view of another known LCD with pixels in its inactive area.

FIG. 2b is a top view of an LCD and circuitry in accordance with an aspect of the present invention.

FIG. 3 is a cross-sectional view of an LCD.

FIG. 4 is another top view of an LCD in accordance with an aspect of the present invention with pixels in the active and inactive areas of a viewing area.

### BEST MODE FOR CARRYING OUT THE INVENTION

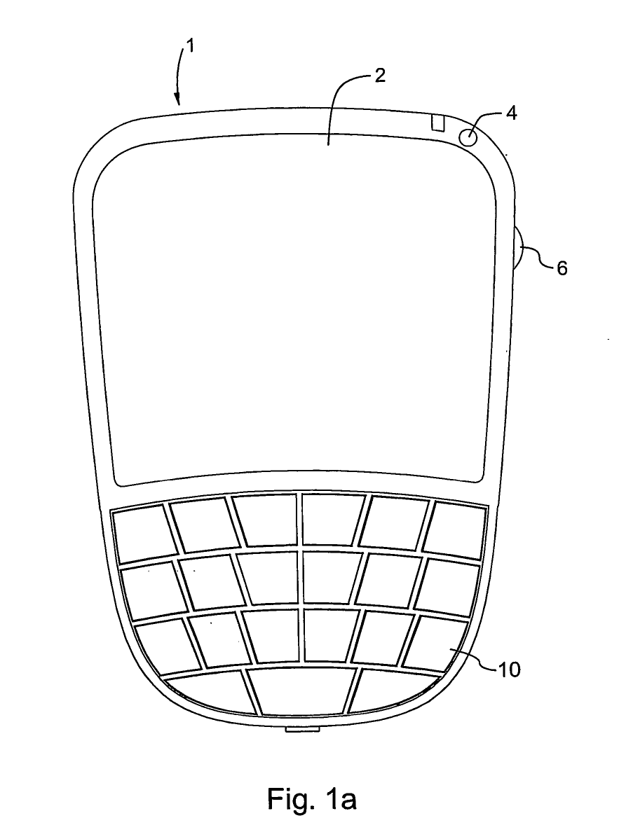

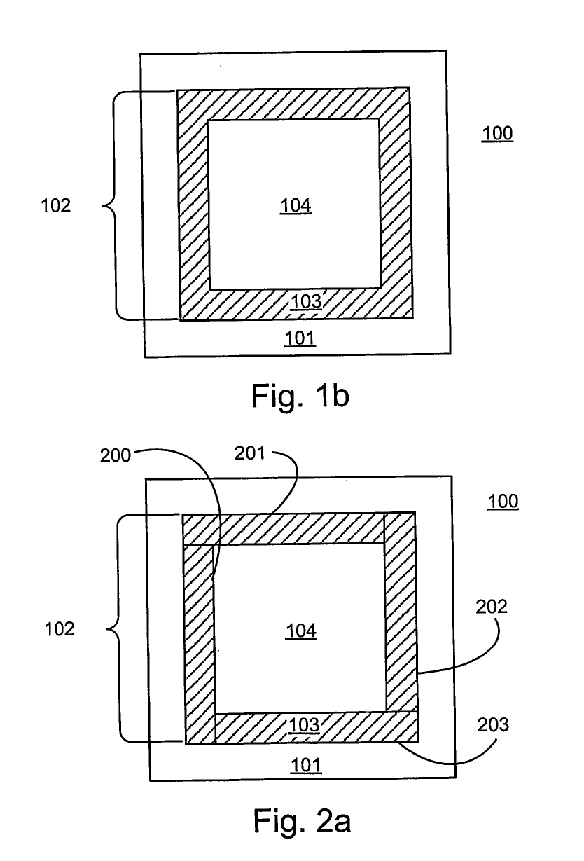

FIG. 1a is a top view of an electronic device with an LCD. The electronic device 1 comprises an LCD 2, an on/off button 4 for turning the electronic device 1 or a component thereof such as a backlight on and off, and a keyboard 10.

FIG. 1b is a top view of a known LCD 100. From FIG. 1, it can be seen that the LCD 100 comprises a glass edge 101, which is the outer edge of the LCD 100, and a viewing area 102 adjacent to and surrounded by the glass edge 101. The viewing area 102 is the area of the LCD 100 that is at least partially visible through a bezel or cut-out in a case or cover of the electronic device 1, and comprises a first area 103, an inactive area, and a second area 104, an active area, adjacent to and surrounded by the inactive first area 103. Normally, the inactive first area 103 has a black or white mask, thereby making the inactive first area 103 either black or white. The active second area 104 of the LCD 100 is a conductive area, within the viewing area 102, wherein images are displayed using pixels.

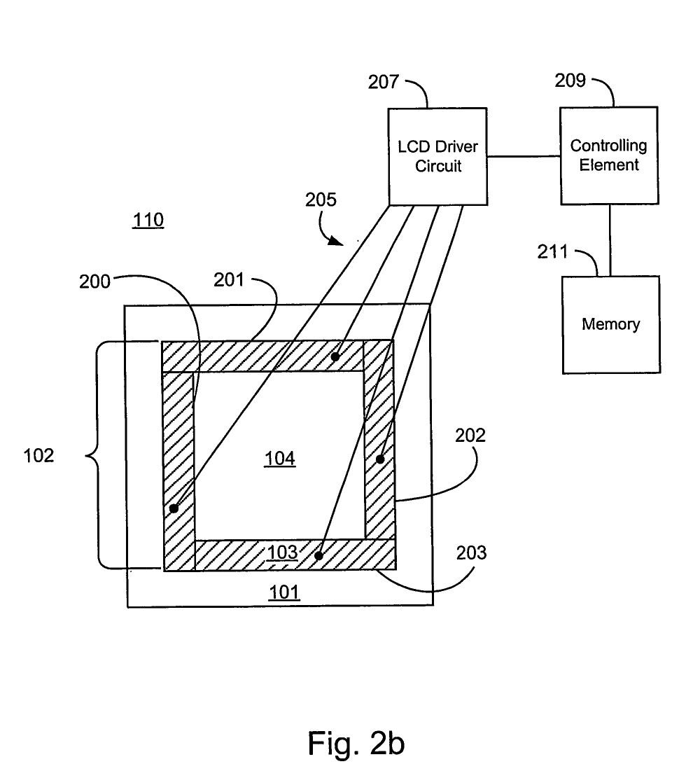

FIG. 2a shows a top view of another known LCD 100 having pixels in its inactive first area 103. In some known LCDs, the inactive first area 103, as shown in FIG. 2a, has four large pixels 200, 201, 202 and 203, each pixel being adjacent to the active second area 104 and the four pixels together forming a rectangular form, so as to surround the active second area 104. The pixels 200, 201, 202 and 203 are usually hard-wired, to be either on so that the inactive first area 103 appears to be black or off so that the inactive first area 103 appears to be white. This means that the pixels 200, 201, 202 and 203 in the inactive first area 104 are typically electrically connected to one of two specific voltage levels, but not connected to any external LCD driver circuits. Instead of being connected to an external LCD driver circuit, the four large pixels 200, 201, 202 and 203 are directly wired to a certain voltage level within the electronic device which determines the colour of the first area 103 as black or white.

FIG. 2b is a top view of an LCD and circuitry in accordance with an aspect of the present invention, wherein drive signals, preferably voltage levels, supplied to each of the four large pixels 200, 201, 202 and 203 through a set of electrical connectors 205 are preferably controlled by software operating on an electronic device in which the LCD is housed. The software may, for instance, be downloaded to a controlling element 209 or a memory 211 associated with the controlling element 209. The controlling element 209, which can be a central processing unit (CPU), a microprocessor, a microcontroller, an application specific integrated circuit (ASIC), or any other controlling element, controls an LCD driver circuit 207 by transmitting electronic signals to the LCD driver circuit 207. The LCD driver circuit 207 supplies each of the four large pixels 200, 201, 202 and 203 with a voltage through the set of electrical connectors 205. The levels of the supplied voltages depend on the signal from the controlling element 209, or may be fixed levels in accordance with a manufacturer's setting selected at the time the device is built. Alternatively, the operating software on the electronic device may also allow the levels of the supplied voltages to be fixed levels selected by a user at any time during the use of the electronic device.

Thus, in the present embodiment, the first area 103 is an active area instead of an inactive area. Alternatively, software applications executing on the electronic device may control the state of the first area 103, by changing the supplied voltages from one set of fixed levels to another set of fixed levels so as to change the colours of the four large pixels 200, 201, 202 and 203 of the first area 103. Thereby, the four pixels 200, 201, 202 and 203 may take on one colour for a first application and another colour for a second application.

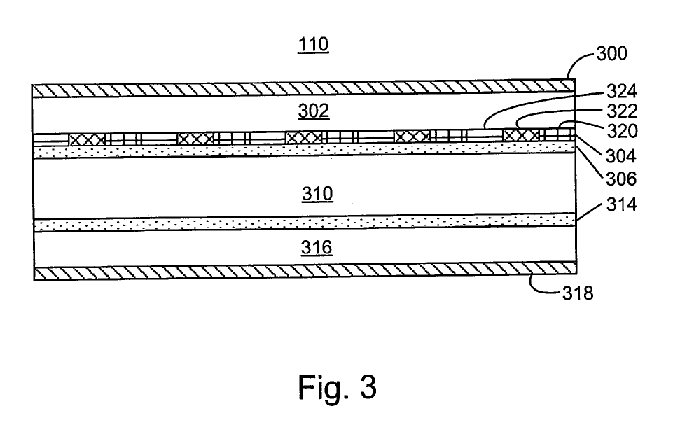

FIG. 3 is a cross-sectional view of an LCD. As is known in the art, the active area of the LCD 110 comprises a top polarizer 300 immediately on top of an upper glass substrate 302, which is on top of a colour filter 304. The colour filter 304 is situated immediately on top of an upper layer of transparent electrodes 306, which is on top of and contiguous to a liquid crystal area 310. The liquid crystal area 310 is sandwiched between the upper layer of transparent electrodes 306 and a lower layer of transparent electrodes 314 and below the lower layer of transparent electrodes 314, a lower glass substrate 316 is situated. The lower glass substrate 316 is adjoint on the bottom surface to a bottom polarizer 318, which forms the bottom of the LCD 110. The bottom of the upper glass substrate 302 and the top of the lower glass substrate 316 are typically brushed to form grooves.

When light enters the top polarizer 300, the light is polarized, such that only light that that is coming from a certain direction is permitted to pass through the top polarizer 300 is coming in from a certain direction. The polarized light passes through the upper glass substrate 302, the colour filter 304 and the upper layer of transparent electrodes 306. When a pixel is not energized, rod-shaped molecules in the liquid crystal area 310 align into the grooves located on the glass substrate 302. The light passes through these grooves into the rod-shaped molecules and is transported through the liquid crystal area 310 by a twisted bridge of rod-shaped liquid crystal molecules. This bridge is aligned at the top of the liquid crystal area 310 with the grooves at the bottom of the upper glass substrate 302 and at the bottom of the liquid crystal area 310 with grooves at the top of the lower glass substrate 316.

The grooves in the lower glass substrate 316 form an angle (in the horizontal plane) with the corresponding grooves in the upper glass substrate 302. This angle is normally 90 degrees, and therefore the twisted bridge of molecules normally has a twist of 90 degrees. However, the angle at which the glass substrates 302, 316 are brushed to form the twist in the liquid crystal area 310 is typically set depending on a desired contrast, a viewing angle, a background colour, or any other factor that is affected by the angle. Thus, this angle is not limited to 90 degrees.

The twisted bridge for a pixel is maintained as long as the molecules are not energized. The light continues through the lower glass substrate 316 and, since it has been twisted 90 degrees, is now coming from a direction perpendicular to the original direction. Therefore, the light also passes through the bottom polarizer 318, which is aligned with a direction of polarization perpendicular to that of the top polarizer 300. The light is then typically reflected by a reflector (not shown), returns through the same path, and exits the LCD. The pixel thus appears to be white.

The electrodes 306 are electrically connected to an LCD drive circuit. The electrodes 306 in conjunction with a layer of transparent electrodes 314 attached on the upper surface of the lower glass substrate 316 are able to drive the pixels in the second area 102. When a pixel is driven, a voltage is placed across the liquid crystal area 310, and the liquid crystal molecules are forced to become perpendicular to the polarizers (in a vertical plane). Light that enters the LCD 100 and passes through the top polarizer 300 is not twisted by the energized rod-shaped liquid crystal molecules, because the molecules in this case do not form a twisted bridge, but instead a straight line of molecules. Subsequently the light can not pass through the perpendicularly polarizing bottom polarizer 318, which absorbs the light. Driven pixels therefore appear as black.

Situated below and touching the upper glass substrate 302 is a colour filter 304. The colour filter has, for each pixel in the second area 102, a red area 320, a green area 322 and a blue area 324. If light enters only a red area 320 of a pixel, the pixel will appear red, if light enters only a green area 322, the pixel will appear green, and if light enters only a blue area 324, the pixel will appear blue. Any combination of red, green or blue is also possible, so that the pixel can appear to be any of 8 colours. Other colour filters with a wider range of colours can also be used.

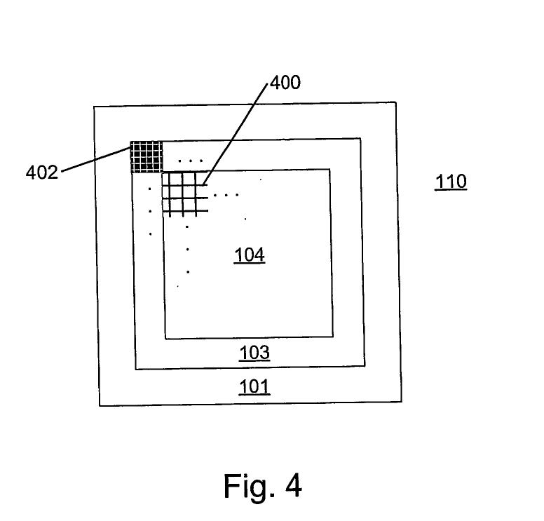

FIG. 4 is another top view of an LCD in accordance with an aspect of the present invention with pixels in the active and inactive areas of a viewing area. As shown in FIG. 4, the pixels 400 of the second area 104 extend as far as the outer edges of the viewing area 102, thus creating a first area 402 with a plurality of pixels. The colour filter 304 (FIG. 3) also preferably extends to the outer edges. The pixels of the first area 402 are electrically connected to the LCD driver within an electronic device along with the pixels in the second area 104. The structure of the first area is then similar to the structure of the second area as described in connection with FIG. 3, although there may be fewer control signals for the first area than for the second area. The pixels of the first area 402 may be addressed to not only display black, white or a single colour through a black, white, or colour mask, but also various colours and patterns as well, since the first area 103 comprises many small pixels, which can be manipulated individually. For instance, a pattern can be displayed by supplying a first voltage to a first group of pixels, comprising at least one pixel, thereby making the first group of pixels display one certain colour, and supplying a second voltage to a second group of pixels, comprising at least one pixel, thereby making the second group of pixels display another colour.

A more complex electrode structure for the first area 103 allows the red, green, and blue areas 320, 322, 324 of the pixels in the first area 103 to be activated or deactivated. With a more complex electrode structure for the first area 103, the first area 103 may be controlled to display different colours, via an LCD drive circuit 207, by software operating on the electronic device in which the LCD 110 is housed. The software may be able to choose between using eight colour depth or full colour depth for the first area 103, full colour depth being defined by the maximum number of colours that the electronic device has capacity to display. The colour or colours of the first area 103 may be set during manufacturing, or the operating software may allow the user to select the colour of the first area 103.

In a further embodiment of the invention, the first area 103 of the LCD 110 may be set differently for different event changes on an electronic device housing the LCD 110. For example, the first area 103 may be set to be one colour or pattern for one event change on the electronic device, while it is set to another colour or pattern for a different application. If the user changes from one application to another, the viewing area 102 changes to the colour or pattern of the new application.

In another example, if a user receives a message on an electronic device having an LCD 110, then the first area 103 of the viewing area 102 may change colour or pattern to alert the user of a new message. As described above, in order to change the colour of the first area, a drive signal is transmitted to the pixels which causes the pixels to light up with the colour corresponding to the drive signal. In order to create a pattern, a first drive signal is transmitted to a first group of pixels and a second drive signal is transmitted to a second group of pixels in the first area.

If the message is urgent, the colour or pattern of the first area 103 may also be changed. In one embodiment, after receiving an event change, the controlling element refers to a look up table to determine the drive signal to be transmitted to the pixels in the first area 103 so that each event change is assigned a separate colour or pattern. For those event changes which are not listed in the look-up table, a default colour or pattern may be selected. These changes in colour or pattern in the first area 103 for event changes on the electronic device, such as message received, urgent message received, new application in use, backlight turned on and backlight turned off, may also be programmed into the operating software of the electronic device or may be a user-selectable option. As described above, to achieve the changes in colour in the first area 103, the first voltage is set to a certain value and to achieve the changes in a pattern, the first and second voltages are set to certain values.

Another embodiment may also change the state of the pixels depending on whether an LCD backlight is on or off. If the backlight is on, the first area 103 takes on one colour and if the backlight is off, the first area 103 takes on another colour. In this manner, the first area is toggled between two colours depending on the state of the backlight.

A further embodiment allows the first area 103 to be dynamically changed based on the images displayed on the electronic device. For example, if the image content is predominantly dark, the controlling element 209 could transmit a drive signal to change the colour of the first area 103 to a dark colour, or if the image content is predominately white or light-coloured, the controlling element could transmit a drive signal to change the colour of the first area 103 to a light colour.

In one embodiment, the first area can be set to display a certain colour to match the colour of the housing of the electronic device at the time of manufacturing. In another embodiment separate colours can be given to one or more pixels in the first area to indicate that a call, e-mail or message from a person belonging to a business-related group has been received, or to indicate that a call, e-mail or message from a person belonging to a private-matter-related group has been received.

The structure of an LCD as described in connection with FIG. 3 is only one of many possible ways of implementing an LCD and it is intended as an example only. The use of a voltage signal for controlling the colour of pixels is similarly illustrative; other drive signals may be used instead.

The above-described embodiments of the present invention are intended to be examples only. Alterations, modifications and variations may be effected to the particular embodiments by those of skill in the art without departing from the scope of the invention, which is defined solely by the claims appended hereto.

### INDUSTRIAL APPLICABILITY

The invention provides improved liquid crystal displays.

1. A method for indicating an event change in a first area of a viewing area of a liquid crystal display (LCD), the LCD viewing area having a second area, surrounded by said first area, for displaying images, the method comprising the steps of:
providing control information;
determining said event change from a list of event changes based on said control information;
determining a first drive signal for said event change; and
supplying a first group of pixels in said first area with said first drive signal, said first group of pixels comprising at least one pixel, thereby controlling a colour of said first group of pixels with said first drive signal.

2. A method as claimed in claim 1, wherein the step of providing control information comprises the steps of:
inputting said control information to an electronic device; and
sending a signal with said control information to an LCD drive circuit from a controlling element of an electronic device housing said LCD.

3. A method as claimed in claim 1, wherein the step of providing control information comprises the steps of:
using a software program with control information resident on an electronic device; and
sending a signal with said control information to an LCD drive circuit from a controlling element of an electronic device housing said LCD.

4. A method as claimed in claim 1, which comprises the further steps of:
supplying a second drive signal to a second group of pixels in said first area, said second group of pixels comprising at least one pixel; and
controlling a colour of said second group of pixels with said second drive signal, thereby creating a pattern within said first area.

5. A method as claimed in claim 4, wherein the colours of said first and second groups of pixels are dynamically controlled based on images displayed in said second area of said viewing area.

6. A method as claimed in claim 4, wherein said control information is provided at the time of manufacturing an electronic device housing the LCD, or selected by a user during operation of the electronic device.

7. A method as claimed in claim 1, wherein said first drive signal is set to a certain value if an event change has taken place.

8. A method as claimed in claim 7, wherein said event change is selected from group consisting of: message received, urgent message received, new application in use, backlight turned on, and backlight turned off.

9. An apparatus for controlling a viewing area of a liquid crystal display (LCD) comprising:
a liquid crystal display (LCD) having a first area for indication of at least one event change and a second area, surrounded by said first area, for displaying images;
a controlling element for determining said at least one event change from a set of event changes and for creating control information corresponding to said at least one event change; and
an LCD driver circuit for transmitting signals to said first area based on said control information for indicating said at least one event change.
